(19) United States
(12) Patent Application Publication
(10) Pub. No.: US 2025/0265617 A1
(43) Pub. Date: Aug. 21, 2025

(54) CHANNEL INCREMENTALITY MEASUREMENT USING CAUSAL FOREST

(71) Applicant: ADOBE INC., SAN JOSE, CA (US)

(72) Inventors: Michael Gao, San Francisco, CA (US); Bei Huang, Mountain View, CA (US); Qilong Yuan, San Jose, CA (US)

(21) Appl. No.: 18/443,489

(22) Filed: Feb. 16, 2024

(51) Int. Cl. G06Q 30/0242; G06Q 30/0201; G06Q 30/0272

(52) U.S. Cl. CPC G06Q 30/0246; G06Q 30/0201; G06Q 30/0272

(57) ABSTRACT

One or more aspects of the method, apparatus, and non-transitory computer readable medium include obtaining content presentation data; generating, using a machine learning model, predicted user interaction data by computing a plurality of decision tree regressors, wherein nodes of the decision tree regressors are trained to infer a causal relationship between a user interaction variable and a treatment variable; and present content to the user based on the predicted user interaction data. The causal relationship is based on maximizing a difference in a relationship between a user interaction variable and a treatment variable of a tree.

### BACKGROUND

The present disclosure relates to measuring causal effects for content channels to optimize content presentation strategies.

In some cases, the impact of user interaction with content can be delayed. Carryover theory refers to the impact of content presentation not being perfectly in phase with user interaction movements, but delayed and spread out over time, so that changes may not be noticeable immediately or measurable right after the content presentation strategy has gone into effect. A campaign carryover effect makes it difficult to analyze the success of a user campaign. Content providers can gauge the effects of content presentation comparing results to a previous period without the content presentation. Content providers, however, may not know when to start the measurement period or how long the measurement period should last to obtain the most accurate result. Various other factors may also change sales amounts.

Mix modeling (MM) is a type of statistical analysis of time series data used to estimate the impact of various content presentation techniques on user interactions, and then forecast the impact of future combinations of inputs on the user interactions. MM defines the effectiveness of each of the input elements in terms of its contribution to user interaction effectiveness (e.g., output volume generated by each unit of effort), and efficiency (e.g., generated output volume divided by cost). It may be used to optimize an input mix of presentation content with respect to output.

In some examples, MM includes analytical approaches that use historic information to quantify the impact of various input and activities that may be accomplished by determining a relationship between various activities and inputs with the output volume during an associated time period. This may be in the form of a linear or a non-linear equation, that may be solved using regression analysis.

### SUMMARY

Embodiments of the present disclosure provide a machine learning model to implement a causal forest with mix modeling (MM) and a transformation that models the delayed and diminishing effects of input for an independent variable on one or more dependent variables. A better understanding of the underlying details of the user interactions including various feature sets, usability differences, and other use case specific attributes can be obtained using a trained machine learning model.

A method, apparatus, and non-transitory computer readable medium for a machine learning model are described. One or more aspects of the method, apparatus, and non-transitory computer readable medium include obtaining content presentation data; generating, using a machine learning model, predicted user interaction data by computing a plurality of decision tree regressors, wherein nodes of the decision tree regressors are trained to infer a causal relationship between a user interaction variable and a treatment variable among the nodes; and presenting content to the user based on the predicted user interaction data.

A method, apparatus, and non-transitory computer readable medium for a machine learning model are described. One or more aspects of the method, apparatus, and non-transitory computer readable medium include obtaining training data including content presentation data and user interaction data, wherein the user interaction data is causally related to the content presentation data; modifying the training data by applying a temporal delay effect to the content presentation data to obtain modified training data; and training a machine learning model to predict user interactions by generating a plurality of decision tree regressors based on the modified training data, wherein nodes of the decision tree regressors are trained to infer a causal relationship between a user interaction variable and a treatment variable among the nodes.

An apparatus and method for a causal inference predictor and incrementality estimator are described. One or more aspects of the apparatus and method include one or more processors; one or more memories including instructions executable by the one or more processors; a transformation component configured to modifying the training data by applying a temporal delay effect to content presentation data to obtain modified training data, and a machine learning model comprising parameters in the one or more memories, and trained to predict user interactions by generating a plurality of decision tree regressors based on the modified training data, wherein nodes of the decision tree regressors are trained to infer a causal relationship between a user interaction variable and a treatment variable among the node.

### BRIEF DESCRIPTION OF THE DRAWINGS

FIG. 1 is an illustrative depiction of a high-level diagram of users interacting with a forecasting system, including a neural network for predicting input incrementalities and user engagement, and receiving through a device a forecast and an input plan, according to aspects of the present disclosure.

FIG. 2 a block diagram of an example of a causal inference predictor, according to aspects of the present disclosure.

FIG. 3 shows a flow diagram illustrating an example of a forecasting system utilizing a causal inference system and methods, according to aspects of the present disclosure.

FIG. 4 shows a pie chart for time varying output values generated in response to content presentation activities, according to aspects of the present disclosure.

FIG. 5 shows a block/flow diagram of a method of generating a plan based on predicting input incrementalities, according to aspects of the present disclosure.

FIG. 6 shows a block/flow diagram of a causal tree, according to aspects of the present disclosure.

FIG. 7 shows a block/flow diagram of a method of forecasting incremental user responses and generating a plan, according to aspects of the present disclosure.

FIG. 8 shows a block/flow diagram of an example of a method of implementing a causal forest and MM to forecast user engagement using a machine learning model, according to aspects of the present disclosure.

FIG. 9 shows a flow diagram of a method of training a machine learning model for predicting user interactions, according to aspects of the present disclosure.

FIG. 10 shows a flow diagram of a method of inferring user interaction data using an incrementality estimator, according to aspects of the present disclosure.

FIG. 11 shows a flow diagram of a method of training a causal inference predictor, according to aspects of the present disclosure.

FIG. 12 shows an example of a computing device for a causal inference system, according to aspects of the present disclosure.

### DETAILED DESCRIPTION

The present disclosure relates to a method of combining causal forest methods with adstock effects and mix modeling (MM) to obtain an incrementality estimator. The incrementality estimator can be applied to discontinuous, time-varying input levels and incremental or interrupted input patterns that were inaccurately estimated by other models.

In various embodiments, the system and method provide an approach to measuring a channel incrementality (e.g., marginal change), that can provide content providers with a deeper understanding of channel and content presentation campaign performance, without the need for controlled experimentation. The percentage of the change in total sales may be attributable to each of a plurality of content presentation effort elements using the method. The proposed approach does not require experimentation and offers a nonlinear perspective to address the modeling limitations of existing methods, making it a valuable addition to the content presentation measurement toolkit.

In various embodiments, the model involves a two-step causal inference approach that combines a data transformation with adstock effects and a causal forest to measure the incrementality of presentation channels and with panel data, where the data transformation allows MM to be applied to panel data. The carry-over effect can be modeled by applying adstock. Adstock is a model of how user interaction builds and decays with time in response to content presentation. Content may be presented via different presentation channels (e.g., media). Presentation channels can include, for example, print, television (TV), radio, internet, and other communication media, that can communicate content to a user. Interaction data can be broken down into different channels, and user interactions associated with content presented through each of the different channels. Causal inference determines whether an observed association reflects an actual cause-and-effect relationship.

According to some aspects, the model utilizes output volume as the dependent variable and the independent variables represent the various content presentation data. Once the independent variables are identified, multiple iterations may be carried out to create a model that correlates the volume and value trends with the various presentation channel efforts. The identification of independent variables for the MM is a complicated affair, which may be as much an art as it is a science.

MM decomposes total output values into base values due to the natural interaction of users with presentation material provided via each of the different channels, long-term trends, and seasonality, and incremental changes in volumes driven by content presentation activities. Presentation activities can include television presentations (e.g., shows, ads, infomercials, etc.), radio presentations, and print presentations (e.g., magazine articles, newspaper articles, etc.). Content presentation may generate long-term and/or short-term returns on investment (ROI). Nonlinear and lagging effects are included using transformations based on a diminishing returns parameter and a temporal delay parameter that describe a delay or decay of a treatment effect, for example, adstock transformations, that model a time decay effect. MM, while robust in many respects, relies on linear regression-based approaches that may not capture the full complexity of user dynamics and activities correlated with presentation efforts.

In various embodiments, a specialized machine learning model may be designed to implement a unique causal forest algorithm, which differs from the standard usage by extending the application of causal forest into time series analysis, thereby enhancing the accuracy and rigor (e.g., stricter requirements for interpretability) of the time series analysis. The causal forest methodology introduces time series transformations that advance beyond existing causal forest approaches by enabling its application to panel data without explicitly violating any causal inference statistical principles. A prediction, statistical inference, or causal inference, thereby, can be obtained from time series data. Incrementality effects may assume a normal distribution for the inference to be valid, and causality predictions can be improved based on more rigorous statistical principles. Both prediction and statistical inference relies on correlation, which does not determine causation. The causal inference methods go beyond correlation to determine how an independent variable causes changes in a dependent variable. MM utilizes correlation to drive statistical inference. A causal forest may not be directly applied to time series data, but by transforming the data by applying an adstock transform, the time series data can be input to the causal forest algorithm for analysis.

A cross-sectional study is a type of observational study that analyzes data from a population or a representative subset collected by observing many subjects at a specific point in time. A sample can be randomly selected from a total population to obtain a cross section of that population. One cross-sectional sample would not describe whether an aspect of the population is increasing or decreasing, but the relative proportions at that point in time. Cross-sectional data is different from time series data, which is observed at various points in time. Cross sectional data provides a snapshot of the population for cross sectional studies. Data collected on sales revenue, sales volume, expenses for a predetermined period is a type of cross-sectional data. Time series data may be collected for the same variable at equally spaced time intervals. Panel data (or longitudinal data) combines both cross-sectional and time series data aspects and examines how the population changes over a time series.

Uncovering causal relationships in data is a major aspect of data analytics. Causal relationships may be discovered based on designed experiments, which can be expensive or infeasible to conduct.

Causal Forests (CF) face significant challenges when applied to time series panel data. An issue involves the violation of the Stable Unit Treatment Value Assumption (SUTVA) due to the autocorrelation inherent in time series data. If SUTVA is violated, one cannot consistently predict the effect of manipulating the exposure on the outcome and thus the causal effect is not unitary or stable. The autocorrelation in time series data implies that the treatment effect on one input unit (e.g., channel presentations) could influence subsequent reactions to additional input units, thereby contradicting the assumption that each unit's treatment is independent. Additionally, the complexities of time-varying confounders and the interaction of past events with current treatments make the direct application of Causal Forests to panel data less straightforward and potentially misleading.

MM may assume a fixed and immediate effect of input variables, overlooking the delayed and cumulative effects and potential non-linear relationships. This can lead to an oversimplified understanding of presentation data and resulting user interactions, particularly in situations with fluctuating input volumes or values, varying channel effectiveness, and evolving user interaction conditions. By applying the transformation model (e.g., adstock) to the input data, the dataset can be transformed in a manner that smooths the impact of input value changes over time. This application of Adstock transformation reduces the issue of autocorrelation and creates a dataset more suitable for causal analysis, where the assumption of conditional independence becomes more plausible.

In various embodiments, the transformation is a Weibull Adstock transformation.

The application of Causal Forests can more effectively adhere to the conditional independence assumption with the use of the transformed data. By including a comprehensive set of covariates, both observed and potential unobserved confounders may be controlled, which can provide a more accurate estimation of causal effects. The use of Causal Forests allows for the estimation of heterogeneous treatment effects, addressing the limitations of MM's linear approach.

One or more aspects of the apparatus and method include utilization of a Causal Forest, where Causal Forest is a machine learning algorithm used to estimate treatment effects in causal inference, and is an extension of the random forest. Causal forest randomly partitions the data into subsets (e.g., treatment groups) and builds a separate decision tree on each subset. The causal forest modifies the standard random forest algorithm by building separate trees for each treatment group, instead of building one tree for the entire dataset. The split criterion used in a causal forest is based on the differences in the average treatment effects between the two child nodes. Heterogeneous treatment effects can be estimated, which allows more accurate and stable estimates of channel incrementality to be obtained from the model(s).

In various embodiments, an algorithm is used for supervised learning tasks such as classification and regression.

Some examples of the method, apparatus, non-transitory computer readable medium, and system further include one or more processors; one or more memories including instructions executable by the one or more processors to obtain content presentation data; generate, using a machine learning model, predicted user interaction data by computing a plurality of decision tree regressors, wherein nodes of the decision tree regressors are trained to infer a causal relationship between a user interaction variable and a treatment variable among the nodes; and present content to the user based on the predicted user interaction data.

Accordingly, embodiments of the disclosure improve on the capabilities of MM and a more robust, accurate, and comprehensive tool for understanding and optimizing presentation effectiveness. This innovative approach overcomes the key technical limitations of applying Causal Forests to time series panel data and significantly enhances the capabilities of MM. This methodology not only represents a technical advancement in fields involving time series panel data analysis, but also has applications in content presentation analytics. The approach presented here overcomes the limitations of traditional methods and provides more accurate and stable incrementality (e.g., marginal change) estimates, especially in cases with variable input levels and sporadic input volume patterns. The proposed approach does not involve experimentation and offers a nonlinear perspective to address the modeling limitations of existing methods, making it a valuable addition to the content presentation measurement toolkit. This also allows high-quality processing of input data prior to inferencing for determining diminishing effects of content presentation on sales or other response variable. Incrementality effects may be assumed to have a normal distribution, and causality predictions can be improved based on more rigorous statistical principles.

As used herein, the term “content presentation data” refers to data describing a content presentation interaction, including the amount of presentation content and presentation durations.

As used herein, the term “user interaction data” refers to data describing user activity generated in response to the content presentations.

As used herein, the term “channels” refers to different media types, including, but not limited to, television, radio, print, and online display content.

As used herein, the term “decision tree regressor” refers to components of a decision tree used to infer a causal relationship.

As used herein, the term “saturation parameter” refers to a value representing a diminishing return. The saturation parameter applies a limit or decay (diminishing return) on content presentation data.

As used herein, the term “temporal parameter” refers to a value representing a degree of decay or delay applied to a calculation.

### Network Architecture

One or more aspects of the apparatus and method include one or more processors; a memory coupled to and in communication with the one or more processors, wherein the memory includes instructions executable by the one or more processors to perform operations including: obtaining content presentation data; generating, using a machine learning model, predicted user interaction data by computing a plurality of decision tree regressors, wherein nodes of the decision tree regressors are trained to infer a causal relationship between a user interaction variable and a treatment variable among the nodes; and presenting content to the user based on the predicted user interaction data. The causal relationship may be based on maximizing a difference in a relationship between a user interaction variable and a treatment variable among the nodes of a tree.

In various embodiments, the content presentation data is processed using a transformation; and MM is applied to the transformed content presentation data. The content presentation data is divided across different channels.

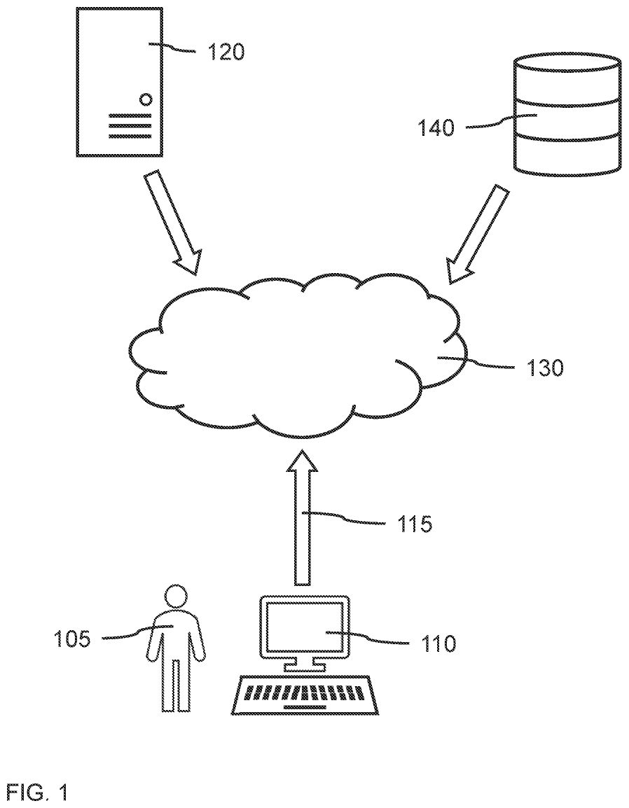

FIG. 1 is an illustrative depiction of a high-level diagram of users interacting with a forecasting system, including a neural network for predicting input incrementalities and user engagement, and receiving through a device a forecast and an input plan, according to aspects of the present disclosure.

In various embodiments, a forecasting system 120 can involve a user 105 who can interact with forecasting system software on a user device 110. A user 105 interacts with the forecasting system 120 using, for example, a desktop computer, a laptop computer, a handheld mobile device, for example, a smart phone, a tablet, a smart tv, or other suitably configured user device. The user device 110 can communicate 115 with the forecasting system 120, which can be a server located on the cloud 130. The forecasting system 120 can generate an estimate for discontinuous, time-varying data, and predict a response to future inputs, where the forecasting system can base the estimate on a model of incrementality (e.g., a marginal response to varying inputs).

Embodiments of the disclosure can be implemented in a server operating from the cloud 130, where the cloud 130 is a computer network configured to provide on-demand availability of computer system resources, such as data storage and computing power. In some examples, the cloud 130 provides resources without active management by the user 105. The term cloud is sometimes used to describe data centers available to many users over the Internet. Some large cloud networks have functions distributed over multiple locations from central servers. A server is designated an edge server if the server has a direct or close connection to a user. In some cases, a cloud 130 is limited to a single organization. In other examples, the cloud 130 is available to many organizations. In an example, a cloud 130 includes a multi-layer communications network comprising multiple edge routers and core routers. In another example, a cloud 130 is based on a local collection of switches in a single physical location.

In various embodiments, the functions of the forecasting system 120 can be located on or performed by the user device 110. Input data can be stored on one or more databases 140, where the databases 140 are accessed over the cloud 130. User device 110 is a personal computer, laptop computer, mainframe computer, palmtop computer, personal assistant, mobile device, or any other suitable processing apparatus. In various embodiments, a user device includes software that incorporates a summarization application. In some examples, the forecasting application on a user device includes functions of the forecasting system 120.

In various embodiments, a user interface enables the user 105 to interact with the user device 110. In some embodiments, the user interface includes an audio device, such as an external speaker system, an external display device such as a display screen, and/or an input device (e.g., remote control device interfaced with the user interface directly or through an I/O controller module). In various embodiments, a user interface is a graphical user interface (GUI). In various embodiments, a user interface is represented in code, which is sent to the user device and rendered locally by a browser.

In various embodiments, a forecasting system 120 can include a computer implemented network comprising a user interface, a machine learning model, which can include, for example, a deep neural network, a transformer model, a natural language processing (NLP) model, a large language model (LLM), and/or an automatic speech recognition model. The forecasting system 120 can also include a processor unit, a memory unit, a search component, a deep learning model, a transformer/encoder, and a training component. The training component can be used to train one or more machine learning models. Additionally, forecasting system 120 can communicate with a database 140 via cloud 130. In some cases, the architecture of the neural network is also referred to as a network or a network model. A neural network model can be trained to perform a data transformation and generate a causal forest using a neural network training technique. The training can be conducted using training data that may be obtained from a source or created

In various embodiments, the neural network is a transformer/encoder.

In various embodiments, the forecasting system 120 is implemented on a server. A server provides one or more functions to users linked by way of one or more networks. In some cases, the server can include a single microprocessor board, which includes a microprocessor responsible for controlling aspects of the server. In some cases, a server uses on or more microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) are used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

A database 140 is an organized collection of data, where for example, database 140 can store data in a specified format known as a schema. Database 140 is structured as a single database, a distributed database, multiple distributed databases, or an emergency backup database. In some cases, a database controller manages data storage and processing in database 140. In some cases, a user 105 interacts with the database controller. In other cases, a database controller operates automatically without user interaction.

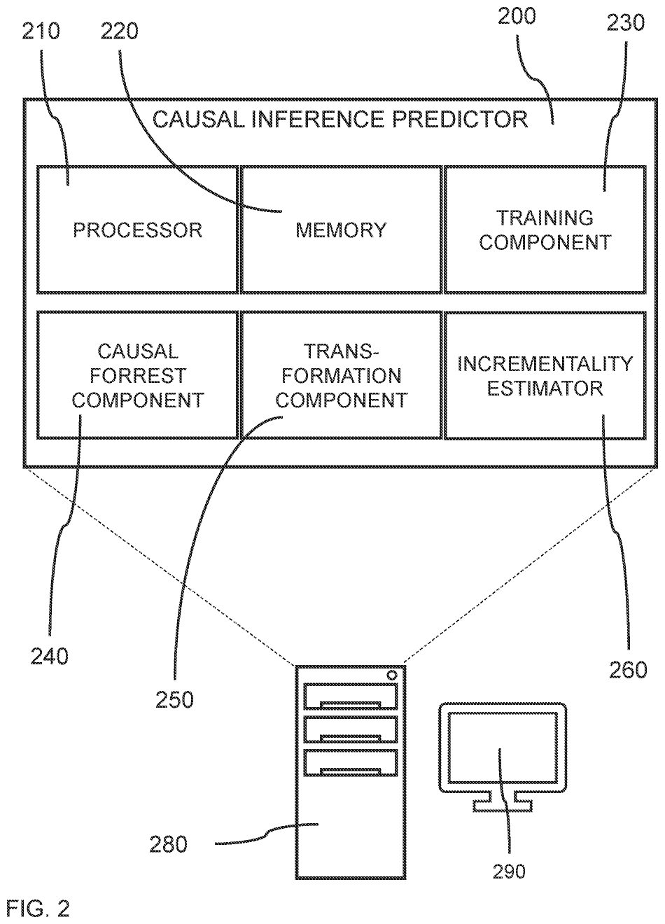

FIG. 2 a block diagram of an example of a causal inference predictor, according to aspects of the present disclosure.

In various embodiments, the causal inference predictor 200 includes a computer system 280 including one or more processors 210, computer memory 220, a training component 230, a causal forest component 240, a transformation component 250, and an incrementality estimator 260. The computer system 280 of the causal inference predictor 200 can be operatively coupled to a display device 290 (e.g., computer screen) for presenting prompts and images to a user 105, and operatively coupled to input devices to receive input from the user, including causal data and training data, for example, content presentation data and user interaction data. The content presentation data can represent the amount of presentation content and presentation durations.

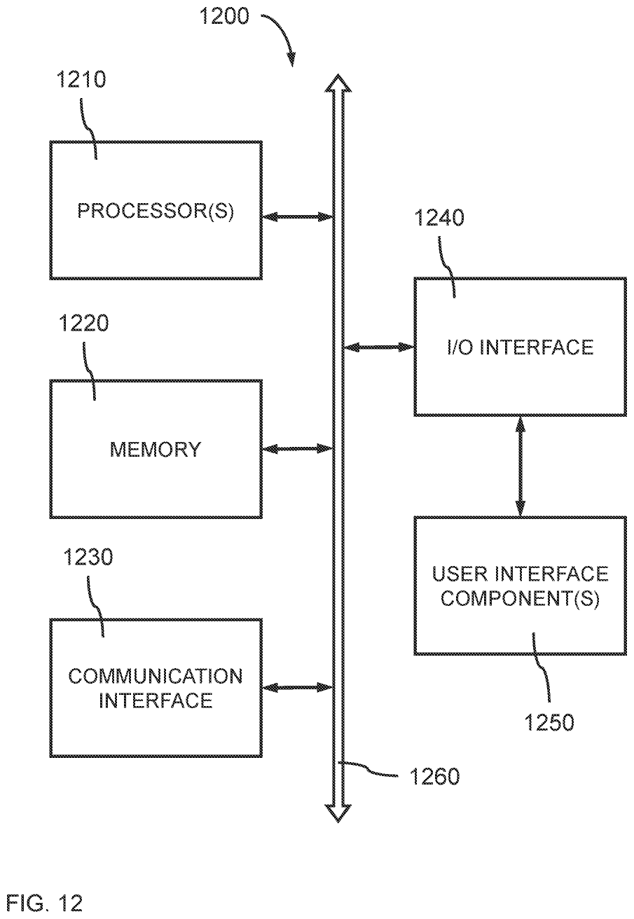

In various embodiments, a processor 210 includes one or more processors. Processor 210 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor 210 is configured to operate a memory array using a memory controller. In other cases, a memory controller is integrated into the processor 210. In some cases, processor 210 is configured to execute computer-readable instructions stored in a memory 220 to perform various functions. In various embodiments, processor 210 includes special-purpose components for modem processing, baseband processing, digital signal processing, or transmission processing. Processor 210 is an example of, or includes aspects of, the processor described with reference to FIG. 12.

In various embodiments, a memory unit 220 includes a memory coupled to and in communication with the one or more processors, where the memory includes instructions executable by the one or more processors to perform operations. Examples of memory unit 220 include random access memory (RAM), read-only memory (ROM), or a hard disk. Examples of memory unit 220 include solid-state memory and a hard disk drive. In some examples, memory unit 220 is used to store computer-readable, computer-executable software including instructions that, when executed, cause a processor to perform various functions described herein. In some cases, memory unit 220 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory unit 220 store information in the form of a logical state. Memory unit 220 is an example of, or includes aspects of, the memory subsystem described with reference to FIG. 12.

In various embodiments, the training component 230 is configured to train the models for the causal forest component 240, the transformation component 250, and the incrementality estimator 260. The training component 230 can utilize training data to configure the weights of one or more machine learning models to perform causal tree construction, MM, and/or infer incremental changes in an output value.

In various embodiments, a causal forest component 240 performs causal tree construction using a computational model that determines the structure of a causal forest for input data. A causal inference approach provides a marginal treatment of changes.

In various embodiments, the transformation component 250 performs a data transformation on input data to allow time-varying data for separate time periods to be treated independently from the data of other time periods. Adstock is the prolonged or lagged effect of presentation content on user behavior, where adstock is a model of how the response to presented content builds and decays in influencing user activities. For example, the original user response that a presentation generated may not yet have occurred before the content of the presentation is changed, leading to a lack of awareness regarding measuring the presentation's effectiveness.

In various embodiments, the incrementality estimator 260 utilizes a trained neural network (e.g., deep neural network, transformed, etc.) to model the incremental changes in an output value or volume compared to the incremental changes in input values in different channels, and identify causal relationships that are presented to the user to obtain additional information for planning user engagement strategies. The variation in the base volume is a good indicator of the strength of user acceptance of the presentation content. The causal relationship may be determined by the relationship between the incremental changes in an output value or volume compared to the incremental changes in input values in different channels.

In various embodiments, an expected mean square error (EMSE) may be utilized to predict the incrementality of treatment effects, rather than predicting an actual value, and thereby predicting the efficiency of the different channels. The effect of new inputs can be inferred based on the predicted incrementality for each of the different channels.

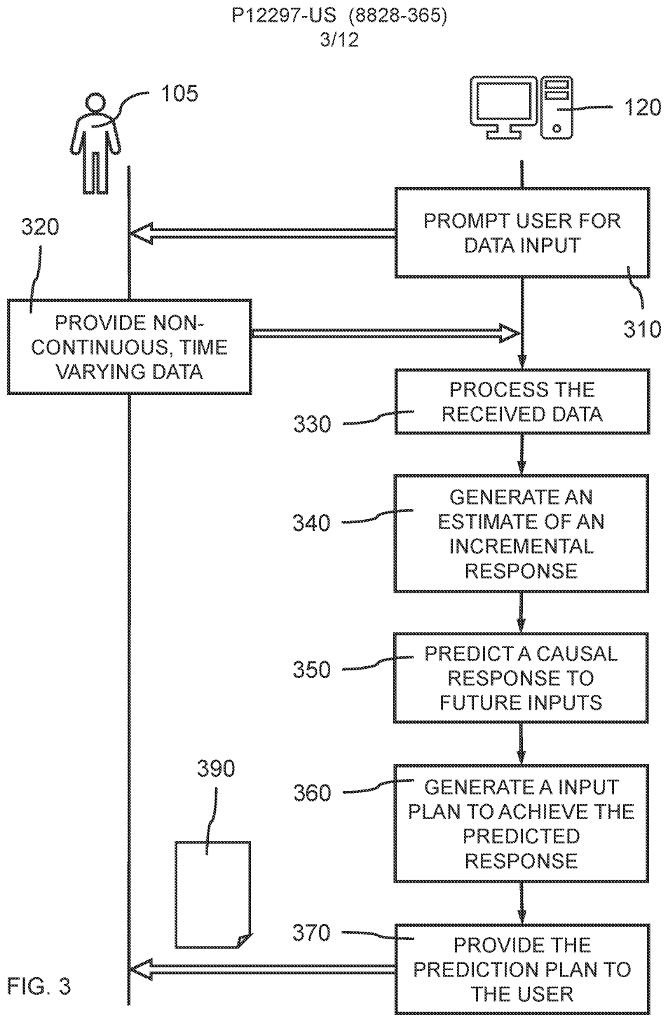

FIG. 3 shows a flow diagram illustrating an example of a forecasting system and methods, according to aspects of the present disclosure.

At operation 310, the forecasting system 120 prompts the user to provide input in a non-continuous, time-varying format.

At operation 320, the user provides the non-continuous, time-varying data. This non-continuous, time-varying data is presentation data.

At operation 330, the forecasting system 120 receives and processes the non-continuous, time-varying data, where the data is transformed into a format usable by MM.

At operation 340, an estimate of an incremental response is generated based on the transformed data. The incremental response can model the expected output value correlated with a change in the input values to represent the predicted marginal change in output.

At operation 350, a causal response can be predicted to future input values, where the input values can be predetermined based on the estimated incremental response and previous predetermined inputs. The input values can be content presentation data.

At operation 360, utilizing the predicted causal response and predetermined inputs, an input plan can be generated to achieve an intended output. The input plan can provide a user with estimated input values to obtain desired outputs, as forecasted by the trained machine learning model.

In various embodiments, causal response is predicted based on a causal forest.

In various embodiments, the output can be forecasted using a transform and MM.

At operation 370, the prediction plan is provided to the user, where the user can view the plan on the user's device.

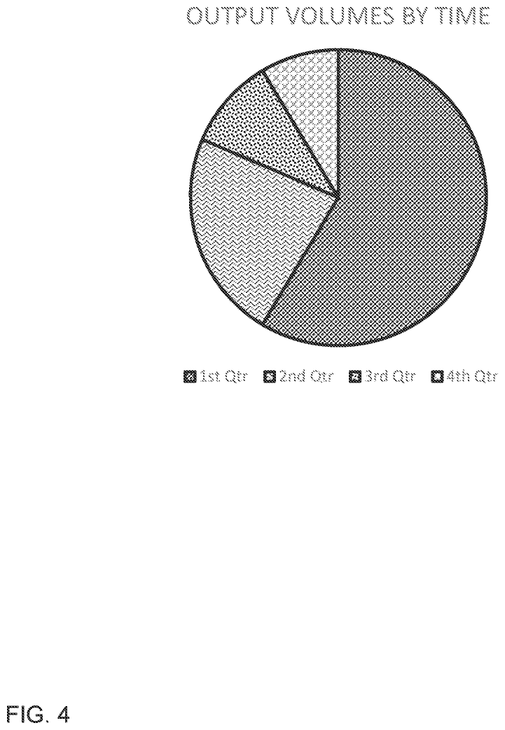

FIG. 4 shows a pie chart for time varying output values generated in response to content presentation activities, according to aspects of the present disclosure.

In various embodiments, a series of data can be generated for distinct time periods, where the data values may be in response to changing input values for one or more independent variables. For example, output values or volumes may result from a baseline amount altered by input variations, where an analysis may be performed to identify the incremental effect of the input value changes for different channels to the output values or volumes.

In various embodiments, the time periods are predetermined based on expected input durations and output durations.

A transformer or transformer network is a type of neural network model used for processing tasks. A transformer network transforms one sequence into another sequence using an encoder and a decoder. Encoders and decoders include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important.

The attention mechanism involves query, keys, and values denoted by Q, K, and V, respectively. Q is a matrix that contains the query (vector representation of one word in the sequence), K represents all the keys (vector representations of all the words in the sequence), and V is the values, which is the vector representations of all the words in the sequence. For the encoder and decoder, multi-head attention modules, V consists of the same word sequence as Q. However, for the attention module that is taking into account the encoder and the decoder sequences, V is different from the sequence represented by Q. In some cases, values in V are multiplied and summed with some attention-weights, a.

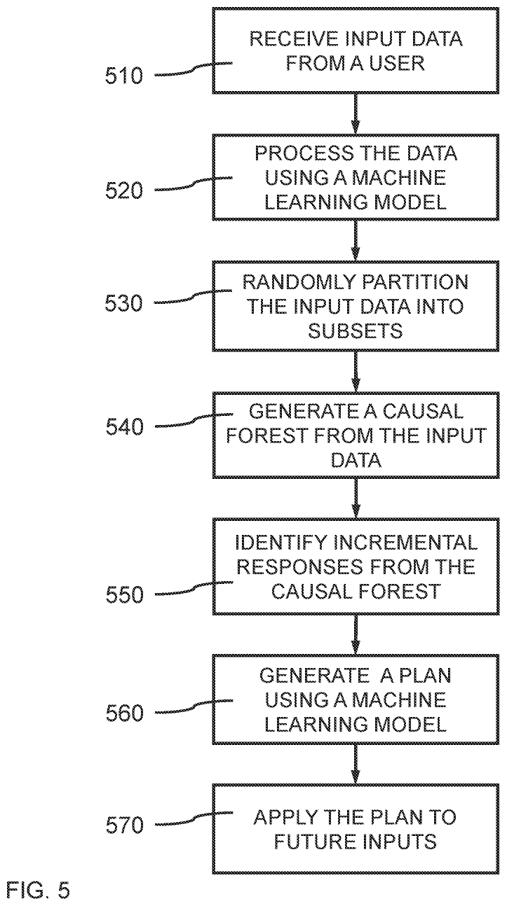

FIG. 5 shows a block/flow diagram illustrating a method of causal forest model generation, according to aspects of the present disclosure.

A Causal Decision Tree (CDT) differs from traditional decision tree model in machine learning, where each of its branch leads to a relationship of causality instead of classification. A node in a CDT indicates a causal factor of an outcome, where the node can be a regressor configured to perform a regression analysis. For example, a stock market index being above or below a threshold value can be a causal factor in luxury item sales.

In various embodiments, a causal forest model, which is a machine learning algorithm, can be used to estimate treatment effects in causal inference, where a causal forest is an extension of the random forest model. A causal forest model randomly partitions the data into subsets and builds a separate decision tree for each subset.

At operation 510, a causal forest model can receive input data from a user, where the input data is discontinuous, time varying data. The input data can relate to a particular occurrence of interest to the user, for example, user engagement. The discontinuous, time varying data can be content presentation episodes utilized to increase user engagement and output values. The input values can be discontinuous in reference to different presentation content placed on various media channels for specific time periods (e.g., durations), which then end after the time period. The input values can be time-varying in reference to changes in amount of presentation content (e.g., episodes) for each subsequent time period.

At operation 520, the input data can be processed using a machine learning model, for example, a transformation to model the time decay effect of the input data based on a temporal parameter. The transformation allows the time-varying data for each separate time period to be considered independent from the data of other time periods. This allows the panel data to be treated as cross-sectional data, and thereby able to be processed by causal forest analysis. The combining of the transformations and the causal forest processing addresses the limitations of traditional MM models and offers a more reliable and robust method for measuring channel incrementality (e.g., marginal change). The combined method improves measuring channel incrementality compared to linear models, and does not involve controlled experimentation. A time period after the content presentation campaign can be chosen to gauge the effects on sales by comparing it to a previous period.

In cases where channel specific content presentation fluctuates significantly over time or when experimental data is unavailable, the described approach can be applied, unlike an independent MM model. For example, content presentation can be sporadic, with occasional significant spikes in expenditure, for example, for prime-time TV slots during events like the Super Bowl. Such high-priced content opportunities are infrequent. Given such non-linear input patterns, the causal forest models, which are adept at capturing complex, non-linear relationships, offer improved modeling, but are difficult to incorporate with the other models. Linear models like MM may be ineffective because the model assumes a constant relationship across variables, which can potentially miss (e.g., smooth out, average out, etc.) nuances in irregular input patterns.

At operation 530, the input data is randomly partitioned into subsets (e.g., treatment groups) for the generation of separate trees in a causal forest.

At operation 540, a causal forest can be generated by generating a set of separate trees based on the partitioned data. A separate decision tree can be constructed based on each subset (e.g., treatment group).

At operation 550, an incremental response to changes in the input data can be modeled and identified. For example, TV content presentations may show a greater marginal change on user activity compared to print content.

At operation 560, a plan for subsequent inputs can be generated based on the incremental responses previously identified, where the plan may be devised to maximize output values based on the incremental responses. For example, a larger portion of input volume can be allocated to TV content to increase output values, where a greater increase in output values occurs for TV content than print content, so an increase in TV content may be included in the future plan with a related decrease in print content.

At operation 570, the plan is implemented, where subsequent input values are altered by the user to meet the plan based on a forecast response to that input. For example, the calculated increases and decreases in presentation episodes for different media channels can be implemented by the user.

In various embodiments, this combined approach solves a specific problem in the field of incrementality measurement. The robustness of the combined approach stems from its ability to handle variable input value levels (e.g., multiple time-varying values) and to estimate channel contributions accurately. The combined approach is an improvement in situations where input levels fluctuate significantly or experimental data is unavailable.

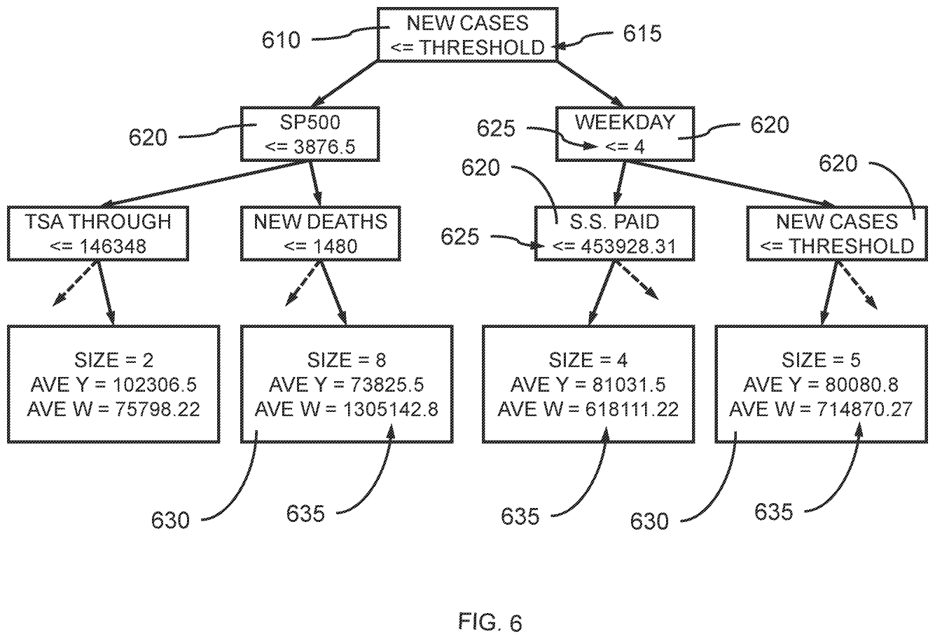

FIG. 6 shows a block/flow diagram of a causal tree, according to aspects of the present disclosure.

With causal inference, there is usually an interest in estimating the causal effect, for example, of a treatment (a drug, an activity, a product, etc.) on an outcome of interest (a disease progression, user health, customer satisfaction, etc.), and estimate heterogeneous treatment effects, where the effect may be an incremental change. Estimating heterogeneous treatment effects allows increased selectively and more efficient alterations to input through targeting. Causal Tree Analysis (CTA) is a structured analytical technique used to identify and analyze the causal factors that contribute to a particular occurrence, for example, promotions of physical activity to improve user health. A Causal Tree is a graphical representation of the occurrence with the outcome at the top of the tree and the various causal factors arranged as branches below it. Each causal factor is then broken down into sub-factors, which may themselves have additional sub-factors, and so on until the root causes of the event are identified.

Causal Forests are a causal inference learning method that are an extension of Random Forests. In random forests, the data is repeatedly split in order to minimize prediction error of an outcome variable, whereas causal forests are built similarly, except that instead of minimizing prediction error, data is split in order to maximize the difference across splits in the relationship between an outcome variable and a “treatment” variable. This is intended to uncover how, for example, treatment effects vary across a sample. Causal forests uncover heterogeneity in a causal effect.

In various embodiments, input data including the collection of factual information and data related to the occurrence is provided to the causal forest component 240 to generate a plurality of causal trees. The differences among trees are created by subsampling, rather than bagging, the training set. The splitting variable at each step is selected from m out of p randomly drawn features or factors. A fraction of the data is used to build each tree. Daily data may be used for training to provide more data points in consideration of sample splitting and subsampling.

In various embodiments, a machine learning model can be trained to identify the conditions associated with an output occurrence, and generate a causal tree based on the identified conditions, where for example, conditions may include financial details (e.g., performance of the economy), timing details (e.g., day of the week, whether paychecks or social security checks were distributed, etc.), etc. The machine learning model can model causal relationships in the input data, where the machine learning model can find causal relationships in the data without domain knowledge or a previously established hypothesis.

In various embodiments, X is a predictive attribute and Y an outcome attribute, where X∈{0, 1} and Y∈ [symbol] _{≥0}, then it can be determined if there is a causal relationship between X and Y. The estimation of the causal effect of Xᵢ on Y is based on the stratified data set D_{S}=sᵢ to avoid unfair comparison. When a comparison is made between elements within a stratified data set, the effect of other attributes on Y is eliminated. Causality based and classification-based criteria do not make the same choice for a causal attribute compared to information gain. Causal relationships may be inferred between a user interaction variable and a treatment variable.

In various embodiments, the causal tree includes a root node 610, branch nodes 620, and leaf nodes 630, where the root node 610 and branch nodes 620 represents a causal attribute 615, 625, an edge denotes an assignment of a value of a causal attribute 625, and a leaf node 630 represents an assignment of a value 635 of the outcome. A path from the root node 610 to a leaf node 630 represents a series of assignments of values of the attributes and a highly probable outcome value 635 at the leaf node 630. (Edges to additional branch nodes or leaf nodes are indicated by a dotted arrow.) Each of the non-leaf nodes has a causal interpretation with respect to the outcome. A context specific causal relationship between a non-root node A and the outcome Y is a refinement of the causal relationship between A's parent and Y.

In various embodiments, a set of causal trees making up a causal forest can be generated based on the training data, where causal trees are generated based on a causal tree algorithm.

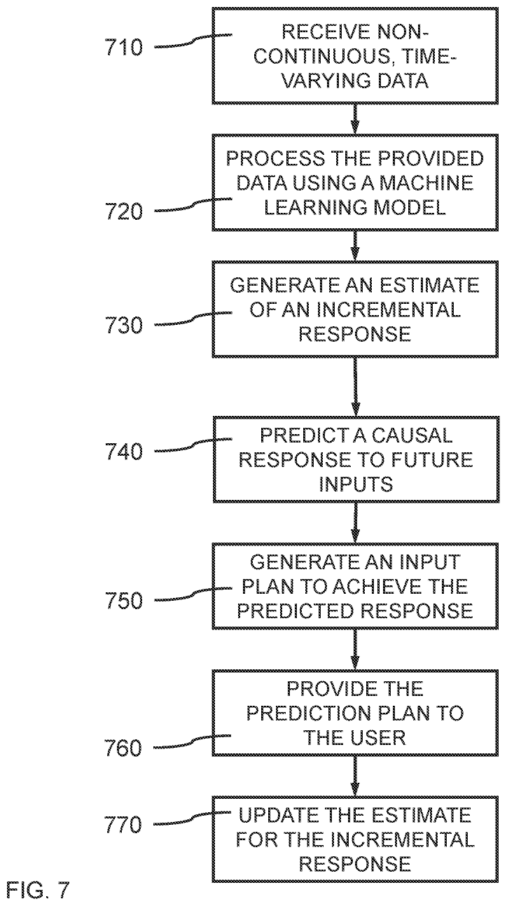

FIG. 7 shows a block/flow diagram of a method of incremental measurement and plan generation, according to aspects of the present disclosure.

At operation 710, the causal inference system 120 receives discontinuous, time-varying data from a user device. The data can include a plurality of variable input values, where the input values can be time-varying content presentations.

At operation 720, the input data can be processed by applying an adstock transformation to the data. The adstock transformation can model the delayed and diminishing effects of input for an independent variable on one or more dependent variables. For example, the adstock transformation can be used to model the delayed and diminishing effects of input values on output values for user engagement or other response variables. The input data can be previously processed utilizing the data transform to obtain the conditional independence of the input data, and allow use of time series data, where for example, what occurs on Monday may be treated as conditionally independent from what occurs on Friday.

At operation 730, an estimate of an incremental response to an input can be generated by a trained machine learning model. The machine learning model can be a neural network trained to generate a causal forest for analysis of the input data. The causal forest can be applied to the data based on an independence of the data. In various embodiments, the input data can be presentation content allocated to different media channels, and the incremental response can be increases and decreases in user engagement or output volume. The input data can be previously processed utilizing the adstock transform to obtain the conditional independence of the input data and allow use of time series data. The causal forest is used to estimate the incrementality of a channel. An MM may be applied to the data to obtain the estimate of an incremental response.

At operation 740, a causal response for future inputs can be predicted based on the estimated incremental responses. Causes for changes in user engagement can be modeled across channels to forecast how changes to content presentation across the different channels incrementally alters the user engagement.

MM can determine the impact generated by individual media channels, such as television, radio, print, and online display content to user activities. In some cases, MM can be used to determine the impact of individual content presentation episodes upon user engagement. For example, for TV channel activity, it is possible to examine how each TV episode has performed in terms of its impact on user engagement and activity.

In various embodiments, the varying effectiveness of content presentation across different channels, time periods, and other covariates, are captured, thereby providing a deeper and more nuanced understanding of user dynamics. Applying Causal Forests to time series panel data significantly enhances the capabilities of MM.

At operation 750, an input plan is generated to achieve the predicted responses based on the causal responses, where an input plan indicates the specific input values to achieve a predetermined result. For example, an input plan may indicate the extent of content presentation to be subsequently made in each of the different media channels to achieve an intended change in user activity and engagement.

At operation 760, the calculated input values can be provided to the user to implement the plan. For example, a channel budget can be revised and presentation content (e.g., episodes) purchases made for each of the media channels.

At operation 770, the estimate for the incremental response may be updated to represent the effect of the new and/or altered input values, which can be used for future plans. The updating and planning can be repeated iteratively to optimize a return on investment.

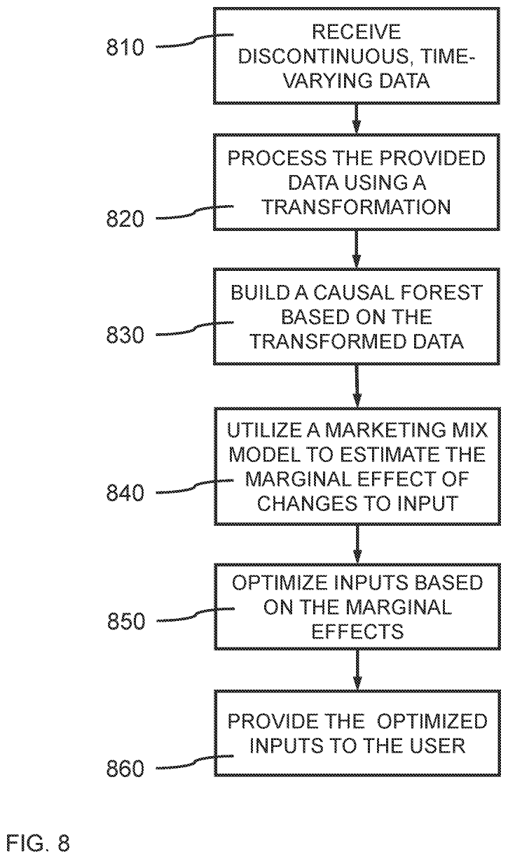

FIG. 8 shows a block/flow diagram of an example of a method of utilizing MM with an adstock transformation and causal forest, according to aspects of the present disclosure.

At operation 810, discontinuous, time-varying data is received by the forecasting system 120. The data can be input to the causal inference predictor 200 to obtain transformed data, determine causal relationships, and infer output values.

At operation 820, the discontinuous, time-varying data is processed using a transformation to obtain input data suitable to build a causal forest, where the transformation can be an adstock transform.

At operation 830, a causal forest is built using the transformed data and a causal tree algorithm.

At operation 840, the MM utilizes the causal forest to estimate the marginal effect of changes to the input data values. The MM utilizes a trained machine learning model.

At operation 850, the input values are optimized based on the marginal effects to increase changes in the output values.

At operation 860, the optimized input values are provided to the user for implementation.

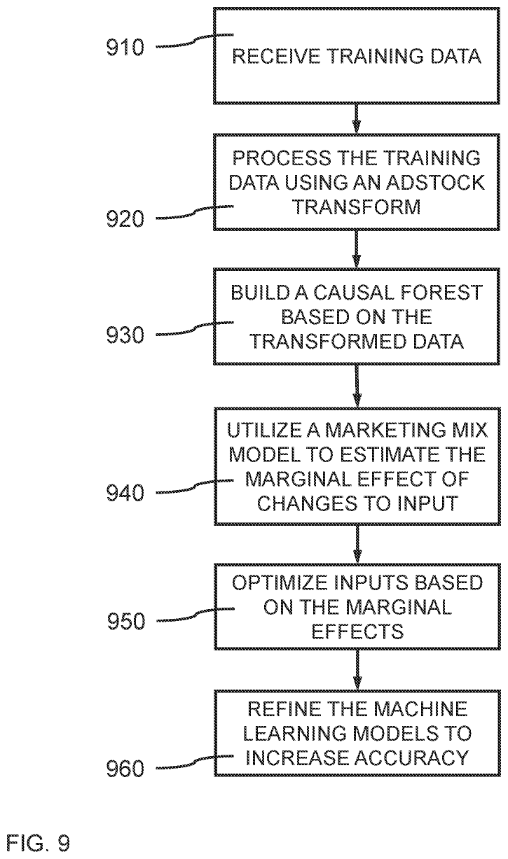

FIG. 9 shows a block/flow diagram of an example of a method of training a summarization model, according to aspects of the present disclosure.

At operation 910, training data is received by the forecasting system 120, where the training data is non-continuous, time-varying data. The training data may be obtained and/or created.

At operation 920, the training data is processed using a transformation, such as a distributed lag model, for example, a Kyock transform or an adstock transform to model lag and decay effects. The transform is based on an assumption that there is a maximum lag beyond which values of the independent variable do not affect the dependent variable, where a model based on this assumption is referred to as a finite distributed lag model.

At operation 930, a causal forest is built using the transformed data and a causal tree algorithm.

At operation 940, MM is used to estimate the marginal (e.g., incremental) effect of changes to the input values on the output values. This is used to forecast user engagement and activities based on content presentation.

At operation 950, the inputs are optimized to achieve an intended result based on the predicted marginal effects. Achieving predetermined output values can be determined by analyzing the marginal changes resulting from input changes across different channels.

At operation 960, the optimized input values are used to refine the machine learning models to provide increased accuracy of the relationships and marginal changes in values. The output can be presented to the user for implementation, for example, in selecting an amount of presentation content and presentation durations and identifying efficient channels for presenting the content. The output can be predicted user interaction data.

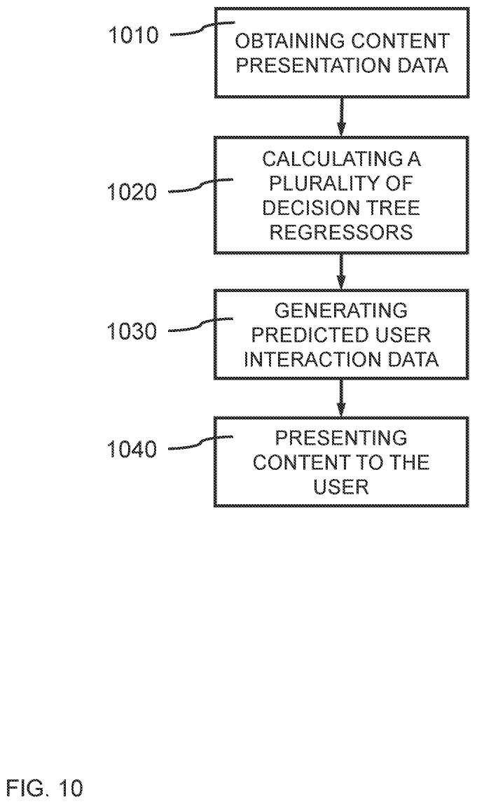

FIG. 10 shows a flow diagram of a method of inferring user interaction data using an incrementality estimator, according to aspects of the present disclosure.

At operation 1010, content presentation data is obtained, where the content presentation data can represent the amount of presentation content and presentation durations through one or more channels.

At operation 1020, a plurality of decision tree regressors are calculated. The nodes of the decision tree regressors are trained to infer a causal relationship between a user interaction variable and a treatment variable, where the causal relationship may be stored as values among the nodes. The causal relationship may be based on maximizing a difference of a relationship between a user interaction variable and a treatment variable among the nodes of a tree.

At operation 1030, predicted user interaction data is generated.

At operation 1040, the content is presented to the user, where the presented content can generate user engagement and activity. The content presented to the user is based on predicted user interaction data. Updated user interaction data may then be obtained from the newly presented content.

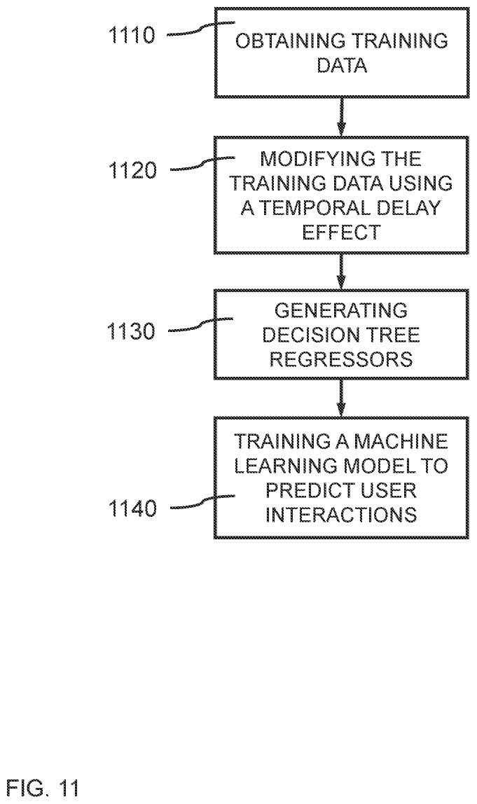

FIG. 11 shows a flow diagram of a method of training a causal inference predictor, according to aspects of the present disclosure.

At operation 1110, training data is obtained, where the training data includes content presentation data and user interaction data. The content presentation data can represent the amount of presentation content and presentation durations. The user interaction data is causally related to the content presentation data.

At operation 1120, the training data is modified by applying a temporal delay effect to the content presentation data to obtain modified training data.

At operation 1130, a plurality of decision tree regressors are generated based on the modified training data.

At operation 1140, a machine learning model is trained to predict user interactions by generating a plurality of decision tree regressors. The user interactions can be predicted using a MM and the decision trees, where the incremental response of user interactions is based on the content presentation data.

Embodiments of the disclosure can utilize an artificial neural network (ANN), which is a hardware and/or a software component that includes a number of connected nodes (i.e., artificial neurons), which loosely correspond to the neurons in a human brain. Each connection, or edge, transmits a signal from one node to another (like the physical synapses in a brain). When a node receives a signal, the nodes process the signal and then transmits the processed signal to other connected nodes. In some cases, the signals between nodes comprise real numbers, and the output of each node is computed by a function of the sum of the node's inputs. In some examples, nodes may determine their output using other mathematical algorithms (e.g., selecting the max from the inputs as the output) or other suitable algorithms for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the layer's inputs. The initial layer is known as the input layer and the last layer is known as the output layer. In some cases, signals traverse certain layers multiple times.

FIG. 12 shows an example of a computing device for a causal inference system, according to aspects of the present disclosure.

In various embodiments, the computing device 1200 includes processor(s) 1210, memory subsystem 1220, communication interface 1230, I/O interface 1240, user interface component(s) 1250, and channel 1260.

In various embodiments, computing device 1200 is an example of, or includes aspects of forecasting system 120. In some embodiments, computing device 1200 includes one or more processors 1210 that can execute instructions stored in memory subsystem 1220 for inference and model training.

In various embodiments, computing device 1200 includes one or more processors 1210. In various embodiments, a processor 1210 can be an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor 1210 is configured to operate a memory array using a memory controller. In other cases, a memory controller is integrated into a processor. In some cases, a processor is configured to execute computer-readable instructions stored in a memory to perform various functions. In some embodiments, a processor 1210 includes special-purpose components for modem processing, baseband processing, digital signal processing, or transmission processing.

A processor 1210 may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor 1210, the functions may be stored in the form of instructions or code on a computer-readable medium.

In various embodiments, memory subsystem 1220 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor 1210 to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1230 operates at a boundary between communicating entities (such as computing device 1200, one or more user devices, a cloud, and one or more databases) and channel 1260 (e.g., bus), and can record and process communications. In some cases, communication interface 1230 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1240 is controlled by an I/O controller to manage input and output signals for computing device 1200. In some cases, I/O interface 1240 manages peripherals not integrated into computing device 1200. In some cases, I/O interface 1240 represents a physical connection or a port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a user interface component, including, but not limited to, a modem, a keyboard, a mouse, a touchscreen, or a similar device. In some cases, the I/O controller is implemented as a component of a processor. In some cases, a user interacts with a device via I/O interface 1240 or via hardware components controlled by the I/O controller.

According to some aspects, user interface component(s) 1250 enable a user to interact with computing device 1200. In some cases, user interface component(s) 1250 include an audio device, such as an external speaker system, an external display device such as a display device 290 (e.g., screen), an input device (e.g., a remote-control device interfaced with a user interface directly or through the I/O controller), or a combination thereof. In some cases, user interface component(s) 1250 include a GUI.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining content presentation data;
generating, using a machine learning model, predicted user interaction data by computing a plurality of decision tree regressors, wherein nodes of the plurality of decision tree regressors are trained to infer a causal relationship between a user interaction variable and a treatment variable; and
presenting content to the user based on the predicted user interaction data.

2. The method of claim 1, wherein:
the content presentation data is divided across different channels.

3. The method of claim 1, further comprising:
processing the content presentation data using a transformation; and
applying mix modeling (MM) to the transformed content presentation data.

4. The method of claim 3, wherein:
the carryover effect is modeled using an adstock transformation.

5. The method of claim 1, wherein:
the plurality of decision tree regressors form a causal forest.

6. The method of claim 1, wherein:
the user interaction variable models user activity in response to the content presentation data.

7. The method of claim 1, wherein:
the node in the decision tree regressors indicates a causal factor of an outcome.

8. A method comprising:
obtaining training data including content presentation data and user interaction data, wherein the user interaction data is causally related to the content presentation data;
modifying the training data by applying a temporal delay effect to the content presentation data to obtain modified training data; and
training a machine learning model to predict user interactions by generating a plurality of decision tree regressors based on the modified training data, wherein nodes of the decision tree regressors are trained to maximize a difference of a relationship between a user interaction variable and a treatment variable.

9. The method of claim 8, wherein:
the training data is divided across different channels.

10. The method of claim 8, further comprising:
processing the training data using a transformation; and
applying mix modeling (MM) to the transformed training data.

11. The method of claim 10, wherein:
the carryover effect is modeled using an adstock transformation.

12. The method of claim 8, wherein:
the plurality of decision tree classifiers form a causal forest.

13. The method of claim 8, wherein:
the user interaction variable models user activity in response to the content presentation data.

14. A system comprising:
one or more processors;
one or more memories including instructions executable by the one or more processors to:
obtain content presentation data; and
generate, using a machine learning model, predicted user interaction data by computing a plurality of decision tree regressors, wherein nodes of the decision tree classifiers are trained to maximize a difference of a relationship between a user interaction variable and a treatment variable; and
present content to the user based on the predicted user interaction data.

15. The system of claim 14, wherein:
the content presentation data is divided across different channels.

16. The system of claim 14, further comprising:
processing the content presentation data using a transformation; and
applying mix modeling (MM) to the transformed content presentation data.

17. The system of claim 16, wherein:
the carryover effect is modeled using an adstock transformation.

18. The system of claim 14, wherein:
the plurality of decision tree regressors form a causal forest.

19. The system of claim 14, wherein:
the user interaction variable models user activity in response to the content presentation data.

20. The system of claim 14, wherein:
the node in the decision tree regressors indicates a causal factor of an outcome.
